(19) United States
(12) Patent Application Publication
(10) Pub. No.: US 2020/0269852 A1
(43) Pub. Date: Aug. 27, 2020

(54) TRAILER CHARACTERISTIC ESTIMATION WITH VEHICLE SENSORS

(71) Applicant: Robert Bosch GmbH, Stuttgart (DE)

(72) Inventors: James Stephen Miller, Dexter, MI (US); Sergio Andres Amaya Correa, Northville, MI (US); Bhavana Chakraborty, Novi, MI (US); Frank Peter Riggi, Plymouth, MI (US); Robert Michael Kaster, White Lake, MI (US)

(21) Appl. No.: 16/286,218

(22) Filed: Feb. 26, 2019

(51) Int. Cl. B60W 40/10; B62D 15/02; B60Q 9/00; G01B 21/02; G01B 21/16; G06T 7/20; G06T 7/70

(52) U.S. Cl. CPC B60W 40/10; B62D 15/025; B60Q 9/00; G01B 21/02; G01B 21/16; G06T 7/60; G06T 7/70; B60W 2300/14; B60W 2420/42; G06T 2207/10016; G06T 7/20

(57) ABSTRACT

A system and method for estimating characteristics of a trailer. The system includes a trailer a vehicle with a sensor, a camera, and an electronic controller configured to receive first data from at least one of the sensor and the camera at a first location relative to the trailer, determine a second location relative to the trailer for the vehicle, the second location being a different location than the first location, generate a signal to move the vehicle from the first location to the second location, receive second data from at least one of the sensor and the camera at the second location, determine a characteristic of the trailer based upon the first data and the second data, and determine a movement behavior of the trailer based upon the characteristic before the vehicle couples to the trailer.

### BACKGROUND

Knowing important characteristics of a trailer, such as the length of the trailer, the number of axles, and the height of the trailer, is important for calculating how a trailer will move when being towed by a vehicle. The accuracy of these dimensions is especially important when the vehicle pulling the trailer is an autonomous or semi-autonomous vehicle, as the dimensions are used to determine how a trailer will move behind the towing vehicle.

### SUMMARY

Often, a driver will not want to take the time to separately measure all of the characteristics of the trailer and input them into a control system of the vehicle. Furthermore, once the trailer is attached to the vehicle, it is difficult to measure all of the necessary dimensions of the trailer using sensors or cameras on the rear of the vehicle.

Therefore, a system is provided for estimating trailer characteristics using vehicle sensors before the trailer is coupled to the vehicle. By estimating the trailer characteristics before the trailer is coupled to a vehicle, more characteristics can be gathered immediately and movement behaviors of the trailer once coupled can be predicted. This allows for better vehicle control once the trailer is coupled, especially for autonomous vehicles.

One embodiment provides a system for estimating characteristics of a trailer. The system includes a trailer, a vehicle, a sensor positioned on the vehicle, a camera positioned on the vehicle and configured to capture video of the trailer, and an electronic controller configured to receive first data from at least one of the sensor and the camera at a first location relative to the trailer. The controller is also configured to determine a second location relative to the trailer for the vehicle, the second location being a different location than the first location, generate a signal to move the vehicle from the first location to the second location, receive second data from at least one of the sensor and the camera at the second location, determine a characteristic of the trailer based upon the first data and the second data, and determine a movement behavior of the trailer based upon the characteristic before the vehicle couples to the trailer.

Another embodiment provides a method for estimating characteristics of a trailer. The method includes receiving, at an electronic controller, first data from at least one of a sensor and a camera at a first location relative to a trailer, determining, with the electronic controller, a second location relative to the trailer for a vehicle, the second location being a different location than the first location, generating, with the electronic controller, a signal to move the vehicle from the first location to the second location, receiving, with the electronic controller, second data from at least one of the sensor and the camera at the second location, determining, with the electronic controller, a characteristic of the trailer based upon the first data and the second data, and determining, with the electronic controller, a movement behavior of the trailer based upon the characteristic before the vehicle couples to the trailer.

### BRIEF DESCRIPTION OF THE DRAWINGS

FIG. 1 illustrates a system for estimating trailer characteristics according to one embodiment.

FIG. 2 illustrates an electronic controller according to one embodiment.

FIG. 3 illustrates a method of estimating a characteristic of a trailer according to one embodiment.

### DETAILED DESCRIPTION

Before any embodiments are explained in detail, it is to be understood that this disclosure is not intended to be limited in its application to the details of construction and the arrangement of components set forth in the following description or illustrated in the following drawings. Embodiments are capable of other configurations and of being practiced or of being carried out in various ways.

A plurality of hardware and software based devices, as well as a plurality of different structural components may be used to implement various embodiments. In addition, embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (for example, stored on non-transitory computer-readable medium) executable by one or more processors. For example, “control units” and “controllers” described in the specification can include one or more electronic processors, one or more memory modules including non-transitory computer-readable medium, one or more input/output interfaces, one or more application specific integrated circuits (ASICs), and various connections (for example, a system bus) connecting the various components.

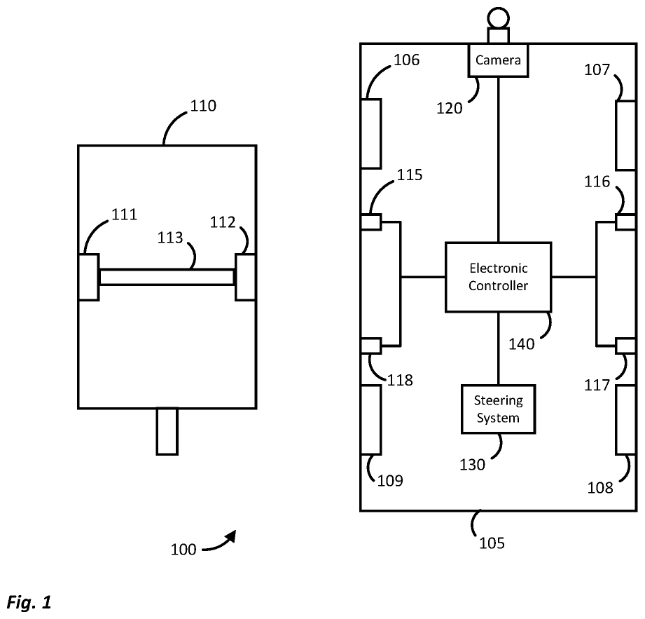

FIG. 1 illustrates a system 100 for estimating trailer characteristics according to one embodiment. The system includes a vehicle 105 with wheels (such as wheels 106-109) and a trailer 110 with wheels (such as wheels 111-112) connected by at least one axle 113. The vehicle 105 and the trailer 110 are uncoupled.

The vehicle 105 may be an automobile, a truck, a motorcycle, a tractor-trailer, and the like. For illustrative purposes, the vehicle 105 is shown with four wheels 106-109, but may have more or less wheels.

The trailer 110 is any attachment for the vehicle 105 that is designed to carry cargo. In the example shown, the trailer 110 has two wheels, wheels 111 and 112, connected by an axle 113. In other embodiments, the trailer 110 may have more wheels connected by the same axle 113 or may have more wheels connected by more axles (for example, a trailer being pulled by a tractor-trailer).

The vehicle 105 includes one or more sensors 115-118. The one or more sensors 115-118 may be ultrasonic sensors, radar sensors, lidar sensors, cameras, or any combination of these. The sensors 115-118 are configured to detect, for example, a distance between the vehicle 105 and the trailer 110 or a presence of the trailer 110 within a detecting range, which is used to estimate a length, height, or other characteristics of the trailer 110 as described below. If the sensors 115-118 are cameras, the sensors 115-118 are configured to collect video of the trailer 110. Based upon the collected video, the system 100 is configured to determine a length, height, number of axles, number of wheels, a width, or other characteristics of the trailer 110 as described below.

The sensors 115-118 may be positioned on various portion of the vehicle 105. In some embodiments, the sensors 115-118 are positioned on a side portion of the vehicle 105 (for example, on a door of the vehicle 105).

The vehicle 105 also includes a rear-view camera 120 positioned on a rear portion of the vehicle 105 (for example, a trunk of the vehicle 105, a rear window of the vehicle 105, a trailer hitch of the vehicle 105, a rear bumper of the vehicle 105, and the like). The rear-view camera 120 collects video of an area behind the vehicle 105, including video of the trailer 110.

The vehicle 105 includes a steering system 130. The steering system 130 may include a steering wheel or other steering device designed to steer the vehicle 105 (for example, interacting with a steering rack and steering pinion to turn wheels of the vehicle 105). The steering system 130 may also include a steering angle sensor configured to detect an angle that the vehicle 105 is being steered at.

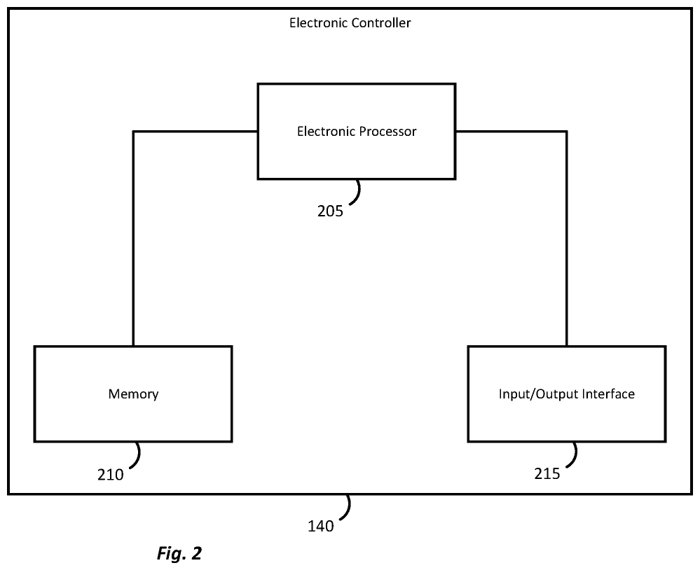

The vehicle 105 also includes an electronic controller 140. An example of the electronic controller 140 is illustrated in FIG. 2.

The electronic controller 140 includes a plurality of electrical and electronic components that provide power, operational control, and protection to the components and modules within the electronic controller 140. In the example illustrated, the electronic controller 150 includes an electronic processor 205 (such as a programmable electronic microprocessor, microcontroller, or similar device), a memory 210 (for example, non-transitory, computer-readable memory), and an input-output interface 215. The electronic processor 205 is communicatively connected to the memory 210 and the input-output interface 215. The electronic processor 205, in coordination with software stored in the memory 210 and the input-output interface 215, is configured to implement, among other things, the methods described herein.

The electronic controller 140, in some embodiments, may be implemented in several independent controllers (for example, programmable electronic control units) each configured to perform specific functions or sub-functions. Additionally, the electronic controller 140 may contain sub-modules that include additional electronic processors, memory, or application-specific integrated circuits (ASICs) for handling input-output functions, processing of signals, and application of the methods listed below. In other embodiments, the electronic controller 140 includes additional, fewer, or different components.

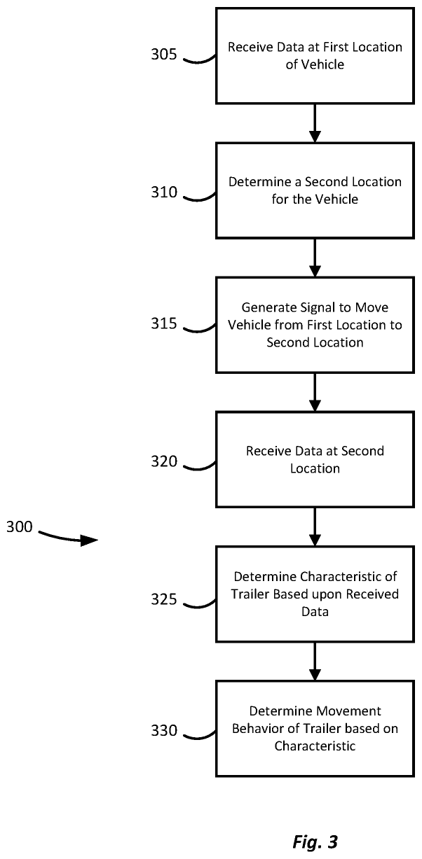

FIG. 3 illustrates an example method 300 of estimating a characteristic of the trailer 110 according to one embodiment. The method 300 includes receiving, with the electronic controller 140, first data from the one or more sensors 115-118 when the vehicle 105 is at a first location relative to the trailer 110 (at block 305). For example, the vehicle 105 may be a distance away from a side portion of the trailer 100 and the sensors 115-118 include lidar sensors. Lidar sensors send out laser pulses and receives reflected pules to detect the presence of a target and determine the distance between the target and the sensor. The sensors 115-118 may therefore detect the presence of a beginning point and an end point of the side portion of the trailer 110 (the length of the trailer 110), which are used to determine a length of the trailer 110 (as described below). The sensors 115-118 may also include cameras, which gather video data of the trailer 110.

In one embodiment, the first location is near a front portion of the trailer 110, and the rear-view camera 120 is configured to gather video data of the trailer 110, the front portion including a coupling point of the trailer 110, such as a trailer tongue.

In some embodiments, the first data includes data from the one or more sensors 115-118 and video data gathered from the rear-view camera 120.

The method 300 also includes determining, with the electronic controller 140, a second location for the vehicle 105 (at block 310). For example, based upon the first data collected at the first location, the electronic controller 140 determines a second location relative to the trailer. The electronic controller 140 determines that the first data includes data indicative of a side portion of the trailer 110 (such as determining, based upon images from cameras of the sensors 115-118, that the side portion of the trailer 110 was captured). The electronic controller 140 then determines the second location to be, for example, a location in front of the trailer 110 (in order to not collect redundant data of the other side of the trailer 110 and to collect data of, for example, a coupling point of the trailer 110 or a width of the trailer 110).

The second location for the vehicle 105 is different from the first location in order to prevent redundancy in data. However, this does not prevent the second location from being close to the first location. For example, the first location may be close to a side rear portion of the trailer 110 and the second location may be close to a side front portion of the trailer 110 in order to correctly determine trailer length or gather data from each of those locations not available at the other, such as gathering information about a coupling point of the trailer at the side front portion.

The method 300 also includes generating, with the electronic controller 140, a signal to control movement of the vehicle 105 from the first location to the second location (at block 315). In one embodiment, if the vehicle 105 is an autonomous vehicle, the electronic controller 140 is configured to generate the signal and send the signal to the steering system 130, which contains a separate electronic controller configured to control the vehicle 105 (for example, steer the vehicle 105). One or more signals from the electronic controller 140 may be used to control the steering system 130, an engine and drivetrain of the vehicle 105, and a braking system of the vehicle 105 to cause the vehicle to steer and move. The generated signal from the electronic controller 140 indicates the second location to move to and the steering system 130 is configured to determine a path from the first location to the second location and along with other vehicle systems then move the vehicle 105 to the second location.

In another embodiment, the electronic controller 140 generates a signal to notify a user of the vehicle 105 (for example, a driver of the vehicle 105) to move the vehicle 105 to the second location manually. The signal is sent to a notification indicator (such as a display screen mounted in a dashboard of the vehicle 105 or a speaker configured to deliver an audio indication of the location) of the vehicle 105. The signal indicates where the second location is located and may also indicate a desired path from the first location to the second location. A desired path is a path that may cover the shortest distance in between the first and second locations while also avoiding or being free of objects or obstacles. For example, the electronic controller 140 may calculate a distance from the first location and the second location and, using geographic coordinates of each of the locations, determine the desired path between the locations. In other embodiments, the electronic controller 140 utilizes video data from cameras (such as cameras included in the sensors 115-118) to determine a desired path from the first location to the second location. In some embodiments, the electronic controller 140 may be configured to determine a plurality of intermediate locations that make up the desired path. For example, the electronic controller 140 may determine that an object obstructs the desired path. If there is an obstruction, the electronic controller 140 may determine the plurality of intermediate locations in order to guide the vehicle 105 around the obstruction to reach the second location.

The electronic controller 140, in some embodiments, is configured to determine a desired path of movement between the first and second location based upon data from the sensors 115-118 and/or the rear-view camera 120. For example, the electronic controller 140 may determine obstacles in a potential movement path between the first and second locations and generates a signal to maneuver the vehicle 105 around the obstacles and sends the signal to the separate electronic controller. In other embodiments, the electronic controller 140 may be configured to display the best path on the display of the vehicle 105.

The method 300 also includes receiving, with the electronic controller 140, second data from the one or more sensors 115-118 at the second location (at block 320). Much like receiving the first data at the first location, the vehicle 105, after moving to the second location, receives data from the sensors 115-118 at the second location (for example, the sensors 115-118 including lidar sensors and cameras).

In some embodiments, the second location is a front portion of the trailer 110, the front portion including a coupling point of the trailer 110, such as a trailer tongue. The second data may include video data gathered from the rear-view camera 120 of the front portion of the trailer.

The method 300 also includes determining, with the electronic controller 140, a characteristic of the trailer based upon at least one of the first and second data (at block 325). For example, based upon sensor data gathered by lidar sensors (number of returns, timing of returns, a period of time of shorter returns versus longer returns), the electronic controller 140 may be able to determine a length of the trailer 110, a width of the trailer 110, a height of the trailer 110, and the like. The electronic controller 140 may also be configured to analyze video data from one or more cameras (such as the one or more sensors 115-118 and/or the rear-view camera 120) to determine a length, width, height, number of axles, number of wheels, a length from an axle of the trailer 110 to a coupling point of the trailer 110, a trailer tongue length of the trailer 110, and the like. In some embodiments, the electronic controller 140 is configured to determine a plurality of characteristics based upon the first and second data.

In some embodiments, the electronic controller 140 is configured to determine the characteristic based upon a combination of the first and second data. For example, the first data may include only lidar sensor readings, which can provide a trailer length estimate to within a few inches. The second data may include video data which, when corroborated with the lidar sensor readings, allows the electronic controller 140 to more accurately determine the trailer length. The electronic controller 140 may include, in the memory 210, a suitable image or video processing software application to process video data or still images to, for example, determine a characteristic of the trailer 110 based upon the video data or still images.

In some embodiments, the characteristic of the trailer 110 is a characteristic of a coupling point of the trailer 110. For example, the electronic controller 140 may be configured to determine a geometry of the coupling point of the trailer 110 in order to determine how the coupling point will attach to the vehicle 105. In another embodiment, the electronic controller 140 may determine a length and width of the coupling point of the trailer 110.

The method 300 includes determining, with the electronic controller 140, a trailer movement behavior of the trailer 110 based upon the determined characteristic(s) (at block 330). For example, based upon a measured length, width, and trailer tongue length of the trailer 110, the electronic controller 140 may be configured to determine how an angle of the trailer 110 relative to the vehicle 105 will change at different speeds of the vehicle 105. In another example, based upon a measured width and number of axles of the trailer 110, the electronic controller 140 may be configured to determine how the trailer 110 will oscillate from a midline of the trailer 110 at different speeds while being towed behind the vehicle 105.

In some embodiments, the movement behavior is determined at least partially based upon a known movement model. While the electronic controller 140 may include a software application in the memory 210 to determine the movement behavior of the trailer 110 based upon the characteristics, the memory 210 may also contain known movement models. Known movement models indicate known movement behaviors for trailers with particular characteristics.

For example, the electronic controller 140 may access the known movement models and compare the determined characteristic(s) to match the characteristics to one of the known movement models (such as a determined length, width, trailer tongue length, number of axles, number of wheels, and the like). Based upon the matched known movement model, the electronic controller 140 determines the movement behavior of the trailer 110.

Thus, embodiments described herein provide, among other things, systems and methods for estimating characteristics of a trailer.

What is claimed is:

1. A system for estimating characteristics of a trailer, the system comprising:
a trailer;
a vehicle;
a sensor positioned on the vehicle;
a camera positioned on the vehicle and configured to capture video of the trailer; and
an electronic controller configured to
receive first data from at least one of the sensor and the camera at a first location relative to the trailer,
determine a second location relative to the trailer for the vehicle, the second location being a different location than the first location,
generate a signal to move the vehicle from the first location to the second location,
receive second data from at least one of the sensor and the camera at the second location,
determine a characteristic of the trailer based upon the first data and the second data, and
determine a movement behavior of the trailer based upon the characteristic before the vehicle couples to the trailer.

2. The system of claim 1, wherein the electronic controller is further configured to send the generated signal to move the vehicle to a separate electronic controller of a steering system of the vehicle.

3. The system of claim 2, wherein the separate electronic controller is configured to control the vehicle to move from the first location to the second location in response to receiving the signal.

4. The system of claim 1, wherein generating the signal to move the vehicle from the first location to the second location includes notifying a user of the vehicle to move to the second location.

5. The system of claim 4, wherein notifying the user includes at least one selected from the group of providing an audio notification to the user and displaying a notification on a display of the vehicle.

6. The system of claim 1, wherein the second location is determined based upon the first data.

7. The system of claim 1, wherein a best path between the first location and second location is determined based upon video from at least one of the sensor and the camera.

8. The system of claim 1, wherein the characteristic of the trailer is at least one selected from the group consisting of a length of the trailer, a width of the trailer, a height of the trailer, a number of axles of the trailer, a number of wheels of the trailer, a trailer tongue length of a trailer, and a distance between an axle and a coupling point of the trailer.

9. The system of claim 1, wherein the electronic controller is further configured to determine at least one characteristic of a coupling point of the trailer based upon at least one of the first and second data.

10. The system of claim 1, wherein the movement behavior of the trailer is further determined based upon a known movement model.

11. A method for estimating characteristics of a trailer, the method comprising:
receiving, at an electronic controller, first data from at least one of a sensor and a camera at a first location relative to a trailer,
determining, with the electronic controller, a second location relative to the trailer for a vehicle, the second location being a different location than the first location,
generating, with the electronic controller, a signal to move the vehicle from the first location to the second location,
receiving, with the electronic controller, second data from at least one of the sensor and the camera at the second location,
determining, with the electronic controller, a characteristic of the trailer based upon the first data and the second data, and
determining, with the electronic controller, a movement behavior of the trailer based upon the characteristic before the vehicle couples to the trailer.

12. The method of claim 11, further comprising sending, with the electronic controller, the generated signal to move the vehicle to a separate electronic controller of a steering system of the vehicle.

13. The method of claim 12, wherein the separate electronic controller is configured to control the vehicle to move from the first location to the second location in response to receiving the signal.

14. The method of claim 11, wherein generating the signal to move the vehicle from the first location to the second location includes notifying a user of the vehicle to move to the second location.

15. The method of claim 14, wherein notifying the user includes at least one selected from the group of providing an audio notification to the user and displaying a notification on a display of the vehicle.

16. The method of claim 11, wherein the second location is determined based upon the first data.

17. The method of claim 11, wherein a best path between the first location and second location is determined based upon video from at least one of the sensor and the camera.

18. The method of claim 11, wherein the characteristic of the trailer is at least one selected from the group consisting of a length of the trailer, a width of the trailer, a height of the trailer, a number of axles of the trailer, a number of wheels of the trailer, a trailer tongue length of a trailer, and a distance between an axle and a coupling point of the trailer.

19. The method of claim 11, further comprising determining, with the electronic controller, at least one characteristic of a coupling point of the trailer based upon at least one of the first and second data.

20. The method of claim 11, wherein the movement behavior of the trailer is further determined based upon a known movement model.
